(19) United States
(12) Patent Application Publication
(10) Pub. No.: US 2026/0275484 A1
(43) Pub. Date: Sep. 17, 2026

(54) AIR TERMINAL COATING

(71) Applicant: Lightning Protection International Pty Ltd, Huntingfield (AU)

(72) Inventors: Franco D'Alessandro, Mount Stuart (AU); Paul John Hollingsworth, Howden (AU); Hannah Jayne King, Hawthorn (AU); Ludwig Wedemeyer, Point Cook (AU); Christopher Charles Berndt, Glen Iris (AU); Rosalie Katherine Hocking, Chadstone (AU); Andrew Siao Ming Ang, Burwood (AU)

(21) Appl. No.: 19/469,319

(22) PCT Filed: Mar. 26, 2024
(86) PCT No.: PCT/AU2024/050276

§ 371 Date: Sep. 25, 2025

(30) Foreign Application Priority Data
Mar. 27, 2023 (AU) 2023900844

(51) Int. Cl. C23C 4/11; C04B 35/46; C23C 4/134; H02G 13/00

(52) U.S. Cl. CPC C23C 4/11; C04B 35/46; C23C 4/134; H02G 13/20; C04B 2235/3217; C04B 2235/3232; C04B 2235/3272; C04B 2235/3275; C04B 2235/95

(57) ABSTRACT

The present disclosure relates to air terminals or components thereof comprising an outer surface that is at least partially coated with a superhydrophilic coating, methods for their preparation and uses thereof.

### CROSS-REFERENCE TO RELATED APPLICATIONS

This application claims priority from Australian Provisional Patent Application No. 2023900844 filed 27 Mar. 2023, the entire contents of which are incorporated herein by cross-reference.

### TECHNICAL FIELD

The present disclosure relates to air terminals or components thereof comprising an outer surface that is at least partially coated with a superhydrophilic coating, methods for their preparation and uses thereof.

### BACKGROUND

During a storm, lightning poses a significant danger to people and property, with high points being particularly vulnerable to lightning strikes. This danger can be mitigated by installing lightning conductors, also known as “air terminals”, on the most likely strike points of buildings, sites or other facilities to direct the lightning safely to ground.

During thunderstorms, the charge of the thundercloud creates a strong, quasi-static electric field that can cause an air terminal device to ionise air surrounding the device in a process called corona discharge. Excessive corona discharge can produce a cloud of space charge above the air terminal, which has the opposite polarity to the thundercloud inducing charge. Such a space charge cloud can shield the air terminal device electrostatically during the critical phase of lightning attachment and hence decrease the likelihood of the air terminal capturing the lightning strike. Thus, excessive corona discharge can make air terminals ineffective or unreliable and result in lightning bypassing the protection system and causing damage and losses to assets and people.

The first air terminals developed were a basic sharp rod conductor (“Franklin rod”) created with the intention of producing a “corona” or “point discharge” in the atmospheric electric fields of a thunderstorm, with a subsequent conversion of the corona into a connecting “upward leader” to meet the downward lightning leader. An effective air terminal requires a continuous, uninhibited upward leader for reliable interception of the downward lightning leader. However, sharp-tipped air terminals produce substantially more corona space charge than blunt-tipped air terminals.

Hence, the placement and geometry of air terminals are also important factors in lightning protection. The response of an air terminal to the lightning downward leader after it emerges from the thundercloud can be passive, as in the case of a Franklin rod, or it can be active, where a dynamic response to the electric field of the downward leader is invoked by some means. With a passive response air terminal, an upward leader is initiated only after the downward leader is close enough to the rod, i.e., the driving electric field is high enough, and, if space charge is present, to overcome the inhibiting effects of that space charge cloud. With an active response air terminal, an upward leader is launched at a predetermined time, when the electric field conditions are suitable for leader propagation.

The optimum air terminal is one that is corona-minimising during the pre-strike phase of a thunderstorm but, upon the initial descent of the downward leader, commences the corona-streamer-leader process in a dynamic response that leads to a continuous upward leader and interception of the downward leader. However, micro-geometric irregularities on the surface of air terminals can compromise the smooth geometric design of a corona minimising air terminal and result in excess space charge generation. Such irregularities most commonly occur via beading of water droplets and from contaminants such as environmental pollution, avian faeces, and the like. In particular, water droplets on the surface of an air terminal, particularly conductive water droplets (i.e., water made conductive by dissolved salts such as sodium chloride or calcium sulphate), can promote corona discharge and cause excessive corona discharge in the electric field of a thunderstorm.

Accordingly, there is an ongoing need for improved or alternative air terminals for reducing corona discharge during the pre-strike phase of a thunderstorm.

### SUMMARY

In one aspect, the present disclosure provides an air terminal or a component thereof comprising an outer surface that is at least partially coated with a superhydrophilic coating, wherein the coating comprises N-doped titanium dioxide (TiO₂) in an amount of at least about 70 wt %, wherein at least about 15 wt % of the TiO₂ is in the form of anatase, and wherein the coating has an average thickness of between about 20 μm and about 300 μm.

In another aspect, the present disclosure provides a lightning protection system comprising an air terminal as disclosed herein.

In another aspect, the present disclosure provides a method for at least partially coating an air terminal or a component thereof with a superhydrophilic coating, the method comprising:
(i) providing a powder feedstock comprising at least about 70 wt % TiO₂, wherein at least about 50 wt % of the TiO₂ is in the form of anatase; and
(ii) at least partially coating an outer surface of an air terminal or a component thereof with the powder feedstock using atmospheric plasma spray (APS) with N₂ as a powder feedstock carrier gas to a thickness of between about 20 μm and about 300 μm.

### BRIEF DESCRIPTION OF THE DRAWINGS

Embodiments of the present disclosure will now be described with reference to the following Figures, which are intended to be exemplary only.

FIG. 1 shows a simplified representation of the function of Guardian Plus™ air terminals.

FIG. 2 shows a photo of the test setup used to assess the corona behaviour of uncoated and coated stainless steel Grade 316 (SS316) air terminal panels in Example 2.

FIG. 3 shows a prototype apparatus in the spray booth used in accordance with Example 2. The panel holder is shown in the expanded box.

FIG. 4. Side view of the robot moving vertically down the panels (purple arrow) as the stepper motor spun the panel holder (red arrow) which was holding four medium size panels in accordance with Example 3. The robot held the plasma torch a constant SOD of 140 mm (green indicator).

FIG. 5. SEM images of a profiled region of a) a coated medium prototype panel; and b) a coated large prototype panel prepared in accordance with Example 3.

FIG. 6. SEM images of the top surface of a) a coated small prototype panel; a) a coated medium prototype panel; and c) a coated large prototype panel prepared in accordance with Example 3.

FIG. 7. Cross-sectional SEM images of a) a coated small prototype panel; a) a coated medium prototype panel; and c) a coated large prototype panel prepared in accordance with Example 3.

FIG. 8. Optical microscope images of the top surface of a) a coated small prototype panel; a) a coated medium prototype panel; and c) a coated large prototype panel prepared in accordance with Example 3.

FIG. 9. Cross-sectional optical microscope images of a) a coated small prototype panel; a) a coated medium prototype panel; and c) a coated large prototype panel prepared in accordance with Example 3.

FIG. 10. Cross-sectional UV optical microscope images of a) a coated small prototype panel; a) a coated medium prototype panel; and c) a coated large prototype panel prepared in accordance with Example 3.

FIG. 11 shows photographs of a) three SS316 coupons after 4 days exposed to bird dropping simulant; and b) a medium prototype panel after 4 days exposed to bird dropping in accordance with Example 3.

FIG. 12 shows photographs of the physical self-cleaning properties of a) a coated medium prototype panel in accordance with Example 3; and b) an uncoated medium prototype panel.

FIG. 13 shows photographs of a coated medium prototype panel after 2 months exposure to environmental conditions showing a) no visible corrosion and b) the superhydrophilic property of the coating in accordance with Example 3.

FIG. 14 shows photographs of a coated medium prototype panel 10 days after exposure to salt spray in accordance with Example 3.

FIG. 15. Photocatalytic degradation of methylene blue dye by coupons (approximately 12.5 cm²) of SS316 and the small, medium and large prototype coatings under UVA light (366 nm).

FIG. 16. Photocatalytic degradation of methylene blue dye by coupons (approximately 10.9 cm²) of SS316 and the medium prototype coating under a daylight solar simulator.

FIG. 17. Nanoindentation hardness of the small, medium and large prototype coatings. Nanoindentation was performed in triplicate, with a total of 300 indents performed for each coating. The large data distribution is due to pores and unmelted anatase in the coating. The median value is given in the box and whisker plot.

FIG. 18. Nanoindentation elastic modulus of the small, medium and large prototype coatings. Nanoindentation was performed in triplicate, with a total of 300 indents performed for each coating. The large data distribution is due to pores and unmelted anatase in the coating. The median value is given in the box and whisker plot.

FIG. 19 shows photographs of the ammonia atmosphere experiment.

FIG. 20 shows photographs of the final prototypes assembled using the coated panels in accordance with Example 3.

### GENERAL DEFINITIONS

Unless defined otherwise, all technical and scientific terms used herein have the same meanings as commonly understood by one of ordinary skill in the art to which this disclosure belongs.

Unless otherwise specified, the indefinite articles “a”, “an” and “the” as used herein, include plural aspects. Thus, for example, reference to “an agent” includes a single agent, as well as two or more agents; reference to “the composition” or “formulation” includes a single composition or formulation, as well as two or more compositions or formulations; and so forth.

As used herein, the term “and/or” includes any and all combinations of one or more of the associated listed items.

As used herein, and unless the context indicates otherwise, the term “about” means±10% of the recited value.

Throughout this specification and the claims that follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The term “consisting of” means “consisting only of”, that is, including and limited to the integer or step or group of integers or steps, and excluding any other integer or step or group of integers or steps.

The term “consisting essentially of” means the inclusion of the stated integer or step or group of integers or steps, but other integer or step or group of integers or steps that do not materially alter or contribute to the working of the disclosure may also be included.

The reference to any prior art in this specification is not, and should not be taken as, an acknowledgment or any form of suggestion that that prior art forms part of the common general knowledge.

Other definitions may be provided throughout the specification.

### DETAILED DESCRIPTION

The present disclosure relates to air terminals or components thereof comprising an outer surface that is at least partially coated with a superhydrophilic coating. Air terminals in accordance with the present disclosure may comprise one or more components, for example, the air terminal may comprise one or more (e.g., one, two, three, four, or more) panels. It is to be understood that the air terminal component(s) in accordance with the present disclosure form at least part of the outer surface of the air terminal. One or more of the air terminal components (e.g., one or more panels forming part of the outer surface of the air terminal) may be coated with a superhydrophilic coating as disclosed herein.

One of the consequences of corona discharge, which emanates from many objects under the elevated electric fields present during a thunderstorm, is the development of a space charge “volume” or “cloud” above the object(s). A space charge accumulation around the top of an air terminal can have a detrimental effect on its ability to initiate and sustain an upward leader. Thus, the presence of space charge above the air terminal makes lightning capture less reliable. The superhydrophilic coatings disclosed herein may reduce the likelihood of unwanted corona discharge from an air terminal in the electric field of a thunderstorm relative to their uncoated counterparts. For example, the superhydrophilic coatings disclosed herein may advantageously reduce the likelihood of corona discharge from an active response air terminal during the pre-strike phase of a thunderstorm (i.e., before a downward leader is initiated) until such time as an upward leader is actively launched.

Provided herein are air terminals or components thereof comprising an outer surface that is at least partially coated with a superhydrophilic coating, wherein the coating comprises N-doped titanium dioxide (TiO₂) in an amount of at least about 70 wt %, wherein at least about 15 wt % of the TiO₂ is in the form of anatase, and wherein the coating has an average thickness of between about 20 μm and about 300 μm.

In the context of the present disclosure, the term “superhydrophilic” when used in relation to a surface coating refers to a property of the coating such that the contact angle of water with the coated surface is about 10 degrees) (° or less. For example, the contact angle of water with a superhydrophilic surface as disclosed herein may be about 10, 9, 8, 7, 9, 5, 4, 3, 5, 4, 3, 2, 1 or 0 degrees. Thus, in an embodiment, the contact angle of water with a superhydrophilic coating as disclosed herein is about 10 degrees or less, about 8 degrees or less, about 5 degrees or less, about 2 degrees or less, or 1 degree or less. Suitable methods and instruments for measuring the water contact angle (or “wettability”) of a surface will be known to those skilled in the art and may include the sessile drop technique and digital videography.

Advantageously, the superhydrophilic coatings disclosed herein may reduce unwanted corona discharge from the outer surface of an air terminal or a component thereof by reducing (relative to the uncoated surface), preferably preventing, the formation of water droplets or “beads” on the surface. A superhydrophilic coating may also impart self-cleaning properties to the surface by promoting “sheeting” of water, which may wash away physical and/or chemical contaminants present on the substrate, such as dirt, debris, bird droppings, deposited salts (e.g., sodium chloride (NaCl) and calcium sulphate (CaSO₄)), sulphur dioxide (SO₂), ammonia (NH₃), and the like, all of which can contribute to unwanted corona discharge. The presence of such physical and chemical contaminants may also accelerate corrosion of the surface. As such, the self-cleaning properties of the coating described herein may also prolong the life of the air terminal. This may be particularly advantageous because air terminals are typically mounted in elevated outdoor environments where physical and chemical contaminants are commonplace and regular cleaning, maintenance or replacement of the devices is difficult and undesirable.

The superhydrophilic coatings disclosed herein comprise N-doped TiO₂ in an amount of at least about 70 wt %, e.g., at least about 70 wt %, 75 wt %, 80 wt %, 85 wt %, 95 wt %, 98 wt %, 99 wt %, or 100 wt %. In certain embodiments, the coating consists essentially of N-doped TiO₂. For example, the coating may contain trace amounts of other substances, which may arise, for example, from the preparation process. The trace amounts of other substances may be present in an amount of less than 5 atomic %, less than 2 atomic %, less than 1 atomic %, or less than 0.5 atomic %. In an embodiment, the superhydrophilic coating consists of N-doped TiO₂. As used herein, “N-doped TiO₂” refers to TiO₂ containing nitrogen atom impurities. Without wishing to be bound by theory, the nitrogen atom impurities may be introduced into the TiO₂ by substitutional N-doping, substitutional NO-doping, interstitial N-doping and/or interstitial NO-doping. However, it is to be understood that other mechanisms may also be partially or completely responsible for introducing nitrogen atom impurities into the TiO₂. Nitrogen doping (N-doping) of the TiO₂ may be achieved using any suitable method known in the art. For example, N-doping of the TiO₂ may be achieved using atmospheric plasma spray (APS) with a nitrogen (N₂) powder feedstock carrier gas, as described elsewhere herein.

TiO₂ exists in two main polymorphic forms, anatase and rutile. At least about 15 wt % of the TiO₂ present in the superhydrophilic coatings disclosed herein is in the form of anatase. For example, at least about 15 wt %, 20 wt %, or 25 wt %, 30 wt %, 35 wt %, 40 wt %, 45 wt % or 50 wt % of the TiO₂ present in the superhydrophilic coatings disclosed herein is in the form of anatase. In an embodiment, at least about 20 wt % of the TiO₂ present in the superhydrophilic coatings disclosed herein is in the form of anatase. In an embodiment, at least about 25 wt % of the TiO₂ present in the superhydrophilic coatings disclosed herein is in the form of anatase. In an embodiment, about 15 wt % to about 50 wt %, or about 20 wt % to about 50 wt %, or about 25 wt % to about 50 wt %, or about 20 wt % to about 40 wt % of the TiO₂ present in the superhydrophilic coatings disclosed herein is in the form of anatase. The anatase content of the N-doped TiO₂ may be determined, for example, using X-ray powder diffraction (XRD).

Nitrogen doping of the coatings disclosed herein may further enhance the wettability and/or photocatalytic properties of the TiO₂. Nitrogen-doped TiO₂ is widely used as a photocatalyst for the decomposition of organic pollutants. Further, anatase exhibits greater photocatalytic activity than rutile under sunlight. When the coatings disclosed herein are exposed to UV light (e.g., from sunlight), the N-doped TiO₂ may react with the water to generate hydroxyl radicals, which may break down organic molecules and microbes adsorbed on the surface, which may be readily washed away with water (e.g., by rain, dew, etc.). As such, the superhydrophilic coatings disclosed herein may advantageously be both physically self-cleaning (i.e., through the superhydrophilic water sheeting mechanism) and chemically self-cleaning (i.e., through photocatalytic activity).

The coatings disclosed herein have an average thickness of between about 20 μm and about 300 μm. For example, the average thickness of the coating may be between about 20 μm and about 300 μm, 20 μm and about 200 μm, 50 μm and about 150 μm, or about 50 μm to about 140 μm, or about 60 μm to about 130 μm. In an embodiment, the average thickness of the coating is about 100 μm. Typically, a coating in accordance with the present disclosure is applied to a surface (e.g., an air terminal surface or a portion thereof) in one or more (i.e., 1, 2, 3, 4 or more) substantially uniform N-doped TiO₂ layers to achieve a desired thickness.

Typically, TiO₂ (including N-doped TiO₂) coatings are applied to a substrate as either thin nanoparticle films or single layer coatings. However, thin films are not typically robust enough to endure outdoor environments for prolonged periods, while single layer coatings are typically superhydrophobic and lack photocatalytic properties. Advantageously, coatings in accordance with the present disclosure may be superhydrophilic, photocatalytic and chemically and physically stable in harsh outdoor environments for prolonged periods (e.g., greater than 5 years, 10 years, 15 years or 20 years). For example, coatings in accordance with the present disclosure may resist corrosion and/or cracking for prolonged periods, e.g., by bird droppings, salt spray, pollution and the like. In some embodiments, the coatings disclosed herein are substantially physically and chemically inert in a salty (5 wt %) humid (35° C.) environment. Further, the coatings may exhibit suitable adhesion strength to remain adhered to the air terminal surface under harsh environmental conditions. As such, the superhydrophilic coatings disclosed herein are particularly suitable for coating the outer surface of an air terminal (or a component thereof).

The texture (or roughness) of the coating is also an important factor in reducing unwanted corona discharge from the outer surface of an air terminal (or component thereof), with smoother surfaces being preferable to rougher surfaces. In certain embodiments, the arithmetic mean height (Sa) of the coated surface may be about 20 μm or less, e.g., about 20 μm, 19 μm, 18 μm, 17 μm, 16 μm, 15 μm, 14 μm, 13 μm or 12 μm, or less. In an embodiment, the arithmetic mean height (Sa) of the coated surface of the coated surface is less than about 20 μm. In an embodiment, the arithmetic mean height (Sa) of the coated surface is about 15 μm or less. In an embodiment, the arithmetic mean height (Sa) of the coated surface is about 12 μm or less. Suitable techniques for measuring surface roughness will be known to those skilled in the art and may include optical profilometry.

The superhydrophilic coating may further comprise one or more additives. For example, additives may be selected to achieve or enhance one or more desired properties of the coating, such as wettability, photochemical activity, surface roughness, adhesion, porosity, hardness, modulus or the like. Such additives may include metals, metal oxides and/or inorganic ceramics, including but not limited to a cobalt oxide (CoOₓ), cobalt titanate (Co₂TiO₄), iron (Fe) an iron oxide (FeOₓ), Al₂O₃, and silica (SiO₂). The coating may comprise additives in amount of up to about 30 wt %, 25 wt %, 15 wt %, 10 wt %, 5 wt %, 2 wt % or 1 wt %. In an embodiment, the coating comprises from about 0.1 wt % to about 10 wt % Co, e.g., in the form of a cobalt oxide and/or cobalt titanate. In an embodiment, the coating comprises from about 0.5 wt % to about 1 wt % Fe, e.g., in the form of iron and/or an iron oxide. In an embodiment, the coating comprises from about 1 wt % to about 5 wt % silica, e.g., in the form of fumed silica. In an embodiment, the coating comprises from about 0.1 wt % to about 25 wt % Al₂O₃. In other embodiments, the coating is substantially free of additives.

The superhydrophilic coatings described herein may be suitable for use with a variety of air terminals. In some embodiments, the air terminal is an active response air terminal. Suitable active response air terminals are described, for example, in AU 2003236435. Suitable active response air terminals also include the commercially available Controlled Advanced Triggering (CAT) and Guardian Plus™ air terminals provided by Lightning Protection International. However, it is to be understood the superhydrophilic coatings disclosed herein may be used with any suitable air terminal surface.

The superhydrophilic coatings disclosed herein may be applied to any suitable surface of the air terminal. It is to be understood that the coating may be applied to a portion of an outer surface of the air terminal or a component thereof to partially coat the surface, or it may be applied to the entire surface (i.e., to coat the entire outer surface of the air terminal or a component thereof). In an embodiment, substantially the entire outer surface of the air terminal or component thereof is coated with the superhydrophilic coating. The surface may be any suitable surface to which the coatings described herein can adhere. A typical outer surface of an air terminal (or a component thereof) may comprise stainless steel, although other surfaces, particularly metallic surfaces, may also be coated in accordance with the present disclosure. Other surfaces that may be coated with the superhydrophilic coatings disclosed herein may include, but are not limited to, glass, ceramic or plastic surfaces. Such surfaces may be coated directly with the superhydrophilic coatings disclosed herein, or they may be treated prior to being coated. For example, the surface may be roughened prior to being coated (e.g., by grit blasting), which may advantageously improve adhesion of the coating to the surface. For example, roughening the surface may improve adhesion by enabling the coating to penetrate cavities on the surface, displace trapped air at the surface and/or lock-on mechanically to the substrate. In an embodiment, the surface is roughened to an arithmetic mean height (Sa) of at least about 3 μm.

A coating in accordance with the present disclosure may be applied to an air terminal (or a portion thereof) using any suitable method known in the art. In particular, the present inventors have found that thermal spray methods may provide suitable coatings for use with air terminals. Such methods may include, but are not limited to, atmospheric plasma spray (APS), vacuum plasma spraying (VPS) controlled atmosphere plasma spraying (CAPS) and suspension plasma spray (SPS). In an embodiment, the coatings disclosed herein are prepared using atmospheric plasma spray (APS).

In the APS method, a plasma torch generates a plasma jet into which a powder feedstock is injected/fed (typically using a powder feeder device), after which the powder particles are heated and propelled by the plasma jet towards the substrate to form a layer on a surface of the substrate, thereby coating the surface of the substrate. The powder feeder device is configured to pneumatically feed the powder feedstock into the plasma jet at a defined flow rate using a selected carrier gas. The powder particles are injected into a plasma torch, where they are heated (e.g., at about 2700° C.) to a partially-of fully-melted state in-flight, and accelerated at high velocity (e.g., at about 200-800 m/s) toward the substrate surface where they make impact. The position of the plasma jet (i.e., the position of the plasma torch) dictates in which direction the partially- or fully-molten particles fly and where the particles will land on the substrate. The impacted particles cool to form splats, which interlock and solidify to form a cohesive coating. The APS method may be performed using any suitable devices and equipment, including conventional APS devices known in the art.

Typically, the feedstock powder carrier gas for the APS method may be nitrogen (N₂), hydrogen (H₂), argon (Ar) or helium (He). However, the present inventors have found that N₂ carrier gas (as opposed to Ar) may provide a superhydrophilic coating as disclosed herein. Thus, in an embodiment, the APS carrier gas is nitrogen. The nitrogen may be of any grade, including but not limited to food grade, N2.0, N3.0, N4.0 or N5.0.

Typically, the substrate surface is roughened prior to applying the coating, for example, using a grit blaster. The plasma torch may be moved in a suitable path and at a suitable speed such that the molten feedstock is deposited on the roughened substrate in a substantially uniform coating of the desired spread and thickness. One or more layers (e.g., 1, 2, 4, 5, 6, or more) of the molten feedstock may be applied to the substrate and subsequent coating layers to achieve the desired final coating thickness.

The APS method may be performed manually or it may be performed using an automated device, for example, using a programmable robot arm to hold the plasma torch. The substrate may be supported during the APS process using a stationary (e.g., a vice) or mobile holder (e.g., a rotating platform). Advantageously, the use of a programmable robot arm to hold the plasma torch in concert with a rotatable substrate holder may enable the coating thickness to be controlled (i.e., by maintaining a constant stand off distance (SOD)) so as to provide a substantially uniform coating of the desired thickness. The distance between the plasma torch and the substrate may also be adjusted to control other properties of the coating, such as the porosity and the cohesion of the coating (e.g., if the torch is too far away, the particles from the jet may be cold by the time they reach the substrate and cannot cohere to form a coating). If the plasma torch is too close to the substrate, the substrate could be melted, damaged or overheated. In an embodiment, the distance between the plasma torch and the substrate (i.e., the SOD) is between about 100 and 200 mm. In an embodiment, the SOD is about 140 mm. However, it is to be understood that the SOD may vary depending on the desired properties of the coating. A skilled person will be able to readily adjust the SOD in order to achieve the desired properties.

A superhydrophilic coating prepared using the APS method may have low porosity, which may reduce surface roughness and/or prevent or minimise the ingress of water if the pores are not interconnected with the surface of the coating. For example, the average pore size of the coating may be between about 3% and about 20%, or about 5% to about 15%, or about 6% to about 13%.

The powder feedstock for the APS method comprises at least about 70 wt % TiO₂, as required in the final coating. However, the feedstock for APS typically requires a greater anatase content than is required in the final coating to account for the phase transformation of anatase that can occur at high temperatures (e.g., at least about 600° C.). Thus, at least about 50 wt % of the TiO₂ present in the powder feedstock may be in the form of anatase, e.g., at least about 50 wt %, 55 wt, 60 wt %. 70 wt %, 80 wt %, 90 wt %, 95 wt %, 99 wt % of the TiO₂ present in the powder feedstock may be in the form of anatase. In an embodiment, at least about 55 wt % of the TiO₂ present in the powder feedstock is in the form of anatase. The feedstock for the APS method may further comprise one or more additives as described elsewhere herein.

The feedstock for the APS method is provided in the form of a powder. The average particle size of the APS feedstock may be selected so as to optimise the flowability of the powder through the pneumatic feedline as well as the chemical and physical properties of the resultant coating. For example, too small a particle size may not be sufficiently flowable through the pneumatic powder feedline, whereas too large a particle size may not melt sufficiently to a form a continuous cohesive coating. The average particle size may between about 25 μm and 150 μm, or between about 25 μm and 125 μm, or between about 25 μm and 110 μm. In an embodiment, the average particle size is between about 45 μm and 106 μm. Preferably, the particles are substantially spherical and dense. The average crystallite/grain size of the APS feedstock may be selected so as to optimise phase transformation of the TiO₂ and thereby control the chemical and physical properties of the resultant coating, with larger grain sizes generally resulting in a lower degree of transformation formation anatase to rutile. Typically, commercially available TiO₂ has an average grain size of less than about 25 nm. The average grain size of the TiO₂ may be about 5 nm, 10 nm, 15 nm, 20 nm, 25 nm, or more.

Thus, also provided herein is a method for at least partially coating an air terminal or a component thereof with a superhydrophilic coating, the method comprising:
(i) providing a powder feedstock comprising at least about 70 wt % TiO₂, wherein at least about 50 wt % TiO₂ is in the form of anatase; and
(ii) at least partially coating an outer surface of an air terminal or a component thereof with the powder feedstock using atmospheric plasma spray (APS) with N₂ as a powder feedstock carrier gas to a thickness of about 50 μm to about 150 μm.

Where the present disclosure relates to a component of an air terminal comprising an outer surface that is at least partially coated with a superhydrophilic coating, an outer surface of the component may be coated with the superhydrophilic coating prior to the component being assembled into an air terminal device, or it may be coated after assembly.

While the superhydrophilic coatings disclosed herein may be particularly suitable for air terminal surfaces, particularly active response air terminal surfaces, it is also contemplated that the coatings may be used in other applications. For example, the coatings may be particularly useful for applications in which it is desirable to reduce the likelihood of corona discharge, for example, aircraft surfaces, electrical insulators, and on power lines.

In an embodiment, the coated air terminals disclosed herein may form part of a direct-strike lightning protection system. The purpose of a lightning protection system is to intercept a lightning strike and direct the lightning current safely to ground. Briefly, a lightning protection system comprises (1) a “direct strike” air terminal device that receives the lightning strike, (2) a downconductor that carries the lightning current down to ground, and (3) an earthing system to dissipate the lightning current into the ground.

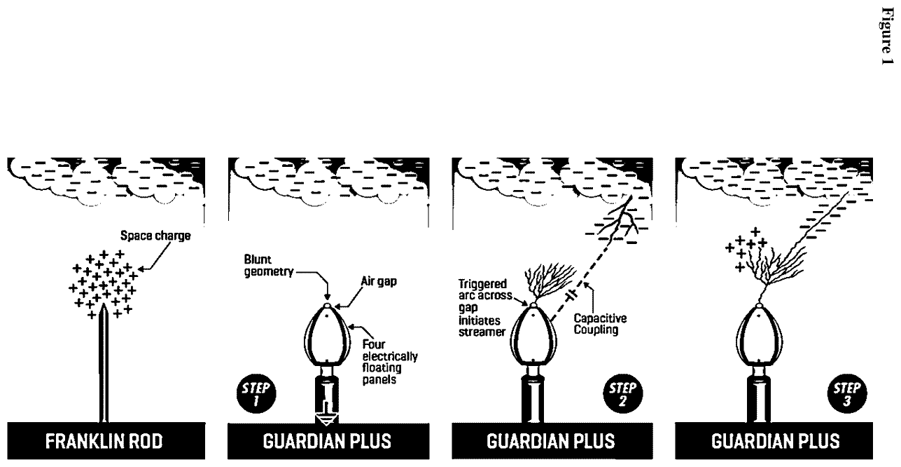

An exemplary lightning protection system that may incorporate an air terminal as disclosed herein will now be described. The lightning protection system comprises a Guardian Plus™ air terminal (Lightning Protection International), but can be readily adapted for use with other air terminals, such as a Guardian CAT™ air terminal (Lightning Protection International). The lightning protection system also comprises a mounting support, downconductor, lightning strike recorder (where applicable), and a dedicated earthing system. The Guardian Plus™ range comprises three sizes of air terminal—the G1+, G2+ and G3+. The smallest size (G1+) is for installations involving lower heights, where corona production is less. On the other hand, the largest size (G3+) is for installation on tall structures, where a very blunt geometry is crucial for minimising corona. The basic function of the Guardian Plus air terminals compared with Franklin rods is represented in FIG. 1. Calculations of the correct size of Guardian Plus™ may be made using LITCalc software (Lightning Protection International). Table 1 provides general guidelines for selecting the correct size of Guardian Plus™ air terminal for installation on mobile base station towers of different height.

TABLE 1
General guidelines for choosing the correct size of Guardian Plus ™ air
terminal for a given height of mobile base station tower.

| Tower | Guardian Plus | Overall |
|---|---|---|
| Height (m) | model | Diameter (mm) |
| <30 | G1+ | 105 |
| 30-60 | G2+ | 158 |
| >60 | G3+ | 213 |

The air terminal placement method preferably complies with the Leader Inception Theory (LIT) as described in IEEE Std. 998. LIT recognises that the initiation of an upward leader from a prospective strike point not only depends on the charge of the downward leader but also on the geometry and position of the point of initiation. Thus, in contrast to traditional methods like fixed angle or the rolling sphere method, LIT requires more complex analysis as it considers variations in geometry and the surroundings of the site. A computational tool validated against the LIT placement methodology, e.g., LITCalc software (Lightning Protection International), may be used to select and position the appropriate number of air terminals along with their individual heights. The LITCalc software performs the complex LIT analysis to position Guardian Plus™ terminals in compliance with IEEE Std. 998. The software can position the Guardian Plus™ terminals on any freestanding structure, such as a base station tower. Firstly, the software assesses the points on the tower that are most likely to intercept a lightning strike. It then assesses suitable terminal positioning, by calculating the attractive radius of the air terminals as a function of their specific location and the tower features. The attractive radius of Guardian Plus™ terminals placed on 30 metre, 45 metre and 60 metre towers is provided in Table 2.

TABLE 2
Indicative attractive radius range for Guardian Plus ™ air
terminals placed upon towers of various heights for Lightning Protection
Level (LPL) III. All values relate to mean sea level. For higher
altitude sites, the attractive radii will be larger than those stated.

| Tower | Attractive |
|---|---|
| Height (m) | Radius range (m) |
| 30 | 49-67 |
| 45 | 56-80 |
| 60 | 63-93 |

A controlled current path to ground may be provided using dedicated downconductor(s), such as standard aluminium or copper conductor(s) for towers without sensitive electronics, or a purpose-designed, insulated lightning cable, such as High Voltage Shielded Cable (HVSC) Plus, for towers with sensitive electronics or where a completely isolated passage of the lightning current to ground is desired. If standard downconductor(s) are used, equipotential bonding kits may be installed to avoid side-flashing into equipment or cables. An earthing system is required that: (i) does not violate the “critical length” for lightning discharges in the soil of the installation, and (ii) dissipates the lightning current with minimum earth potential rise. The latter may be met by achieving a resistance of less than 10Ω (or 5Ω in some cases). If 10Ω cannot be achieved in virgin soil, an earth enhancing compound may be applied around the earth electrodes in accordance with manufacturer's instructions, e.g., RESLO, SRIM Plus. The choice of earth enhancing compound may be determined by the environmental conditions and parameters existing at the site.

The air terminal may be constructed robustly with an earthed conductive rod surrounded by a stainless steel spheroid. The latter may be comprised of four separate panels that are electrically isolated from, and surround, the central rod. The insulation material used to electrically isolate the panels may comprise a base polymer that provides high ozone and UV resistance with a dielectric strength of 24-38 kV/mm. The overall shape of the air terminal may be such that it will limit the development of “point discharge” or “corona space charge” under quasi-static thunderstorm conditions for its height and location of installation. The central rod may be elevated above the spheroid to a length of 16 mm. The upper section of the central rod may be rated to withstand a minimum lightning discharge current of 100 kA±10%, tested and certified in accordance with the relevant sections of IEC 62561-1 and IEC 62561-2 in an accredited laboratory following relevant standards, e.g., IEC 60060-1 and IEC 62475. An air gap may be provided between the individual, electrically-isolated panels and the tip of the central rod. Arcing may occur between the panel sections of the spheroid and the rod tip only upon the approach of a lightning downward leader. The air terminal may have no moving parts and may have no dependence upon external power supply or batteries. Preferably, all components of the advanced lightning terminal shall be corrosion resistant under normal atmospheric conditions and is preferably installed in a non-corrosive environment. If a “high voltage shielded cable”, such as HVSC Plus, is used as a downconductor, the air terminal may be insulated from all surrounding points and features of the structure being protected. The air terminal may be installed in accordance with the manufacturer's instructions and may be tested and certified in accordance with the relevant sections of IEC 62561-1 and IEC 62561-2 in an accredited laboratory following relevant standards, e.g., IEC 60060-1 and IEC 62475.

The mounting pole used to support the air terminal may be with a cylindrical mast, comprised of an insulating fibreglass tube or a metallic tube, with a relative height of at least 2 metres with respect to the highest adjacent points. If a fibreglass pole is used, it may have an outer diameter of 68 mm. The mounting pole and supports may be fixed securely with brackets and guy wires where required. The downconductor may pass through the centre of the pole for the entire length of the pole.

Other suitable lightning protection systems for use with the air terminals disclosed herein, and processes for their assembly, will be apparent to those skilled in the art.

Those skilled in the art will be aware that the present disclosure is subject to variations and modifications other than those specifically described. It is to be understood that the present disclosure includes all such variations and modifications. The disclosure also includes all such steps, features, methods, compositions and compounds referred to or indicated in this specification, individually or collectively, and any and all combinations of any two or more of said steps or features.

Certain embodiments of the disclosure will now be described with reference to the following examples, which are intended for the purpose of illustration only and are not intended to limit the scope of the generality hereinbefore described.

### EXAMPLES

### Example 1. Coating Preparation

Bespoke feedstock formulations with cobalt-based, aluminium oxide (Al₂O₃, alumina) and iron-based additives were prepared. Anatase powder from Sigma Aldrich (product number: 248576) and anatase powder from Startrack (product number: WP0098) were used as the TiO₂ support to prepare the feedstock formulations with the additives listed in Table 3. The cobalt additive was cobalt (II) sulphate heptahydrate salt, the iron additive was iron (II) sulfate heptahydrate, and the alumina (Al₂O₃) additive was Metco 101SF.

Sigma Aldrich (248576) TiO₂ was characterised by XRD to be 100% anatase and to have a grain size of 20 nm, and was characterised using dynamic light scattering (e.g., using a Malvern Panalytical Zetasizer Ultra instrument) to have a mean particle size distribution centred at about 478 nm. Startrack (WP0098) TiO₂ was characterised by XRD to be 100% anatase and to have a grain size of 5 nm, and was characterised using dynamic light scattering (e.g., using a Malvern Panalytical Zetasizer Ultra instrument) to have a mean particle size distribution centred at about 4230 nm.

The nano-sized Sigma Aldrich (248576) and Startrack (WP0098) TiO₂ materials were agglomerated, impregnated with cobalt and iron ions (where applicable), and co-agglomerated with Al₂O₃ (where applicable) using the incipient wetness preparation method. MilliQ water (18 MΩ cm) was used throughout the incipient wetness process. The point of incipient wetness was determined for the Sigma Aldrich (248576) and Startrack (WP0098) TiO₂ powders to be 0.5 mL water to 1 g of TiO₂, which equated to 55 mL of water for the 110 g of TiO₂ used.

The incipient wetness preparation method generally involved preparing the TiO₂ support by drying the TiO₂ powder (e.g., 110 g) in a metal tray (e.g., 26×20 cm, 3 mm bed thickness) in the oven under vacuum (e.g.,-1 bar at 110° C. for 2 hours), then preparing the ionic solution of cobalt (II) or Fe (II) (where applicable) by weighing the required quantity of cobalt (II) sulphate heptahydrate salt or iron (II) sulfate heptahydrate into a standard flask (e.g., 50 mL) and filling to mark with water. The cobalt or iron solution was added to the dried TiO₂ support and additional water (5 mL) was used to rinse the standard flask onto the TiO₂ support to sum the total water volume to that required by the point of incipient wetness (e.g., 55 mL). The aluminium oxide powder was co-mixed with the dried TiO₂ and 55 mL of water was added. The mixture was stirred until combined (e.g., 5 minutes with a micro spatula) and then dried (e.g., placed onto a hotplate at 100° C. or dried in the oven with intermittent stirring for 2 hours). As the mixture dried, large agglomerates formed. The large agglomerates were crushed to form a semi-dry free flowing powder, which was then completely dried (e.g., in a metal tray 26×20 cm, 3 mm bed thickness, in the oven at 110° C. for 1 hour).

TABLE 3
Feedstock formulations.

| TiO₂ source | Additive | Formulation |
|---|---|---|
| Sigma Aldrich TiO₂ | N/A | N/A |
| Sigma Aldrich TiO₂ | Cobalt (II) sulfate | 1. TiO₂ + 0.1 wt % Co |
| | heptahydrate | 2. TiO₂ + 5 wt % Co |
| | | 3. TiO₂ + 10 wt % Co |
| Sigma Aldrich TiO₂ | Alumina | 4. 75 wt % TiO₂ + 25 wt % Al₂O₃ |
| Sigma Aldrich TiO₂ | Iron (II) sulfate | 1. TiO₂ + 0.5 wt % Fe |
| | heptahydrate | 2. TiO₂ + 1 wt % Fe |
| Startrack TiO₂ | N/A | N/A |
| Startrack TiO₂ | Cobalt (II) sulfate | 1. TiO₂ + 5 wt % Co |
| | heptahydrate | |

The coatings associated with the feedstock formulations listed in Table 3 were prepared on a stainless steel Grade 316 (SS316) substrate from each formulation using atmospheric plasma spray (APS) with spray parameters as summarised in Table 4.

TABLE 4
APS parameters used to prepare coatings from the feedstock formulations in Table 3.

| | Formulation | | |
|---|---|---|---|
| | 1. TiO₂ (controls)* | 1. TiO₂ (controls)§ | 1. Al₂O₃ (400 A)§ |
| | 2. Co series† | 2. Fe series§ | |
| | | 3. Al₂O₃ (500 A)§ | |
| Substrate | 1 mm thick SS316 | 1 mm thick SS316 | 1 mm thick SS316 grit |
| | grit blasted | blasted | grit blasted |
| Grit blasting | Black beauty, | Black beauty, | Black beauty, |
| | 0.3 MPa | 0.3 MPa | 0.3 MPa |
| Plasma torch type | Metco ™ 9MB | Metco ™ 9MB | Metco ™ 9MB |
| Powder feeder rate (rpm) | 2 | 2 | 2 |
| Ar 5.0 (SLPM) | 30 | 30 | 30 |
| H₂ 5.0 (SLPM) | 15 | 15 | 15 |
| Current (A) | 500 | 500 | 400 |
| Powder feedstock carrier | Ar 5.0 | N₂ food grade | N₂ food grade |
| gas type | | | |
| Powder feedstock carrier | 9 | 9 | 9 |
| gas flow rate (mL/min) | | | |
| Air jets on torch and blade | 0.2 | 0.2 | 0.2 |
| (MPa) to cool the substrate | | | |
| Stand off distance (mm) | 90 | 90 | 90 |
| Nozzle speed (mm/s) | 150 | 300 | 300 |
| Average number of passes | 10 | 10 | 10 |

*Sigma Aldrich (248576) and Startrack (WP0098) TiO₂ used in the synthesis
†Sigma Aldrich (248576) and Startrack (WP0098) TiO₂ used in the synthesis
§Sigma Aldrich (248576) TiO₂ used in the synthesis

The feedstock feed rate (using a rotating disc powder feeder) and stand off distance were optimised to produce a good plasma plume (e.g., a stand off distance of 90 mm was selected for this 9 MB plasma torch), and the nozzle speed was optimised for reduced heating of the SS316 substrate (e.g., a nozzle speed of 150 mm/s and 300 mm/s was chosen). Argon 5.0 was used as the powder feedstock carrier gas initially, then N₂ food grade was examined. N₂ 5.0 was also used to prepare replicate TiO₂ (Sigma Aldrich control samples), with no measured difference between the samples. The plasma power was varied for the Al₂O₃ powder feedstock as Al₂O₃ is a flux agent (e.g., 500 A and 400 A were used).

In summary, the Ar carrier gas produced a hydrophilic coating, as measured by sessile drop water contact angle, whereas the N₂ carrier gas produced a superhydrophilic coating (i.e., <10 degrees), as measured by sessile drop water contact angle according to the method described in Example 4 below.

### Example 2. High Voltage Tests

High voltage tests were performed at the Lightning Protection International (LPI) manufacturing facility.

### Aim

Since the overall aim of the coating technology to be applied to air terminals is to minimise corona discharge (via superhydrophilicity), it is important to ensure that the surface roughness of the TiO₂ coatings will not enhance corona discharge in any appreciable manner. Hence, the aim of the testing was to apply a high voltage to a nearby spherical electrode, which in turn creates electric field stress at the surface of the SS316 panel. This electric field stress can give rise to a measurable corona current. The overall aim was to test the hypothesis that the corona current will not be significantly different between an uncoated and coated SS316 panel.

### Equipment and Methodology

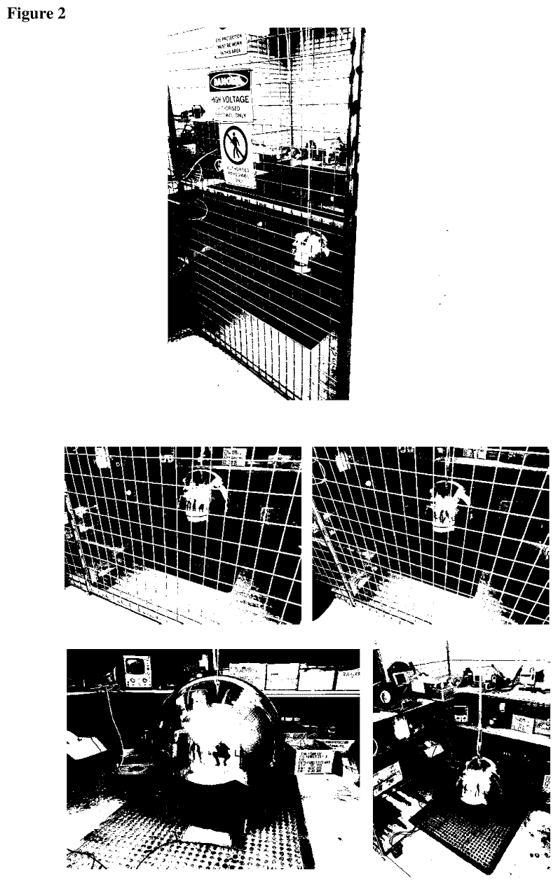

Testing was carried out in accordance with the layout as shown in FIG. 2. The following parameters were used for the testing:
HVDC generator output: 20 kV
HVDC polarity (applied to the sphere): Positive
Gap between the sphere and SS316 panel: 100 mm
SS316 panels:
   Uncoated: Standard panel stamped by LPI for air terminals.
   Coated: F-TiO₂ (no additives), 100 μm coating thickness, Sa=10 μm, as supplied by Swinburne.
Current measurement: “CurrentRanger” that is auto-ranging across currents of nA/μA/mA
   see https://lowpowerlab.com/guide/currentranger/for more details

### Results

With 20 kV applied to the HV spherical electrode and other parameters as listed above, the corona current flowing from the SS316 panel in both cases was very similar, namely, around 1000±100 nA (or 1.0±0.1 μA).

### CONCLUSION

It appears that the TiO₂ coating on the SS316 panels does not significantly increase the amount of corona discharge from the surface. The results indicate that a coating roughness of Sa=10 μm did not increase corona discharge from the SS316 substrate. All coating formulations had a surface roughness in the region of Sa=13+4 μm, which was acceptable for LPI.

### Example 3. Prototype Production

The raw powders listed in Table 5 were obtained from international TiO₂ manufacturers capable of producing tonne-scale quantities and trialled as commercially viable feedstocks.

TABLE 5
TiO₂ feedstock manufacturers and the preparation method required for APS.

| TiO₂ Manufacturer | | | |
|---|---|---|---|
| Company name | Product name | Properties | Preparation required for APS |
| Loman | LA101 | | Required fumed SiO₂ and sieving >25 μm |
| | | | to be flowable enough for APS. |
| Loman | LA100 | | Required fumed SiO₂ and sieving >25 μm |
| | | | to be flowable enough for APS. |
| Cathay | F31GS (2019; | ~35% average particle | Powder required sieving between 45- |
| | 1 kg batch) | size between 45-106 μm | 106 μm to produce a coating with good |
| | | ~90% anatase content | physical properties, else the coating had |
| | | | too many unmelts. |
| Cathay | F31GS (2021; | ~10% average particle | Powder required sieving between 45- |
| | 30 kg batch) | size between 45-106 μm | 106 μm to produce a coating with good |
| | | ~55% anatase content | physical properties, else the particle size |
| | | | was too large, and the feedstock doesn't |
| | | | melt enough to form a continuous |
| | | | coating. |
| Nanochemazone | Custom product: | | Material was not on spec and was |
| | 40-106 μm | | unusable. |

Cathay F31GS 30 kg batch (manufactured in 2021) was selected as the powder feedstock for prototype production. To prepare the Cathay F31GS material for APS, the particle size of the raw F31GS powder was reduced by crushing and sieving the powder. The resulting feedstock had particle size distribution of 54-106 μm and contained about 55 wt % anatase.

APS spray parameters were optimised for the F31GS prototype feedstock as shown in Table 6.

TABLE 6
APS parameters used to prepare coatings from the prototype feedstock.

| | | F31GS prototype feedstock |
|---|---|---|
| | Plasma torch type | Metco ™ Sinplex |
| | Grit blasting | Garnet 30/60, 0.3 MPa |
| Carrier gas | Powder feeder rate (rpm) | 2 |
| | Carrier gas type | N₂ food grade |
| | Carrier gas flow rate | 200 kPa, 7.5 slpm |
| Plasma torch | Ar 5.0 (NLPM) | 52 |
| | H₂ 5.0 (NLPM) | 6 |
| | Current (A) | 500 |
| | Power (kW) | 53.4 |
| | Voltage (V) | 106.4 |
| Air jets for substrate | Air jets on torch (MPa) | 0.2 |
| cooling | Air jets on floor (MPa) | 0.2 |
| Robot | Stand off distance (mm) | 140 |
| | Nozzle speed (mm/s) | 150 |
| | Average number of passes on panels | 25 |

Small, medium and large stainless steel prototype panels suitable for use with both the LPI “Guardian” families of air terminals were coated with the F31GS coating.

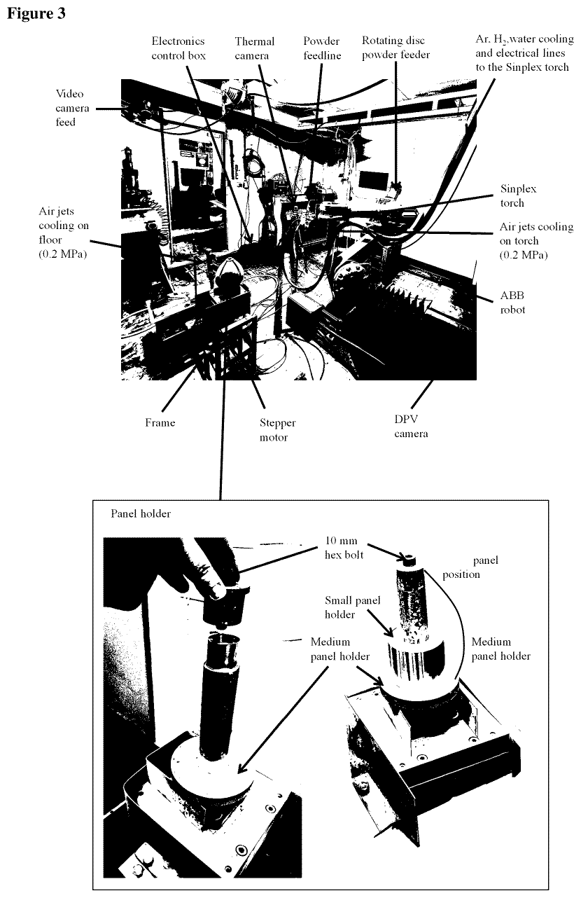

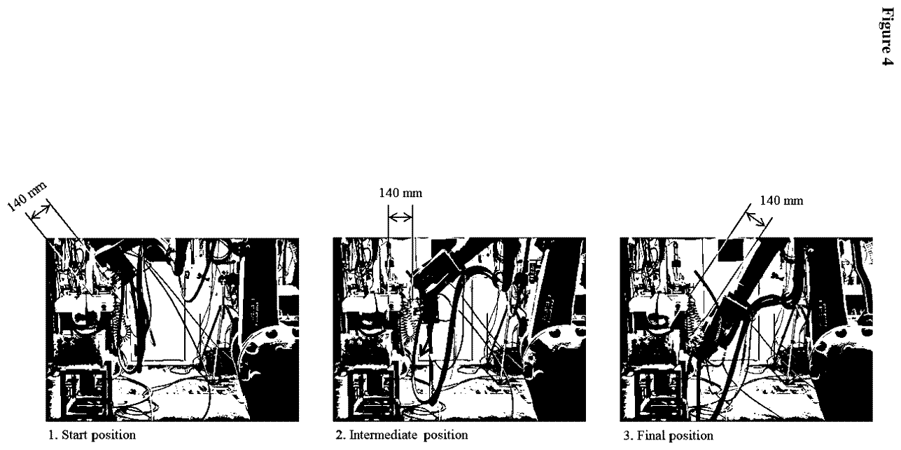

An apparatus was constructed for evenly coating the panels consisting of a panel holder, a stepper motor, a frame to hold the panel holder and stepper motor, and an electronics control box as shown in FIG. 3. The preparation method involved placing four panels (of one size) in the panel holder, then rotating the panel holder while simultaneously moving the robot vertically down the panel in a path that kept the plasma torch a constant SOD of 140 mm from the panel. This process is illustrated in the sequential photos shown in FIG. 4. The panel holder was rotated using a stepper motor, which was programmed using a MEGA 2560 Protoboard and controlled using the ABB robot controller.

The speed at which the panel holder spun was correlated to the position of the robot such that the nozzle surface speed was constant. The nozzle surface speed was programmed based on the time it took for the robot to traverse the face of the panel (i.e., one pass). The time for one pass was chosen such that the temperature of the substrate did not exceed 300° C., which was monitored by a thermal camera (FIG. 3). The APS process settings for the small, medium and large panel sizes are provided in Table 7.

TABLE 7
APS process settings for the small, medium and large size prototype panels.

| | Small panel | Medium panel | Large panel |
|---|---|---|---|
| Stand off distance (mm) | 140 | 140 | 140 |
| Path time (s) | 8.45 | 14.6 | 36.0 |
| Surface speed (mm/s) | 700 | 900 | 1950 |
| Cooling process between each pass | Cooling time of 20 s with the panel holder rotating | | |
| (while the plasma was kept on) | at 60 rpm and the floor air jets at 0.2 MPa | | |
| Average number of passes in a set | 5 | 4 | 3 |

| | |
|---|---|
| Cooling time after a set of passes | Cooling time of 60 s with the panel holder rotating |
| | at 60 rpm and the floor air jets at 0.2 MPa |

In total, approximately 20 kg of raw F31GS (2019; 1 kg batch) powder was required for prototype production, which comprised 40 small, 40 medium and 40 large panels. This equated to approximately 4.5 kg of total prototype feedstock, which is 2 kg F31GS<106 μm±2.5 kg F31GS>106 μm crushed to 45-106 μm. The average mass of feedstock required per panel and the average mass of coating produced per panel for a given panel size is given in Table 8.

TABLE 8
The average mass of feedstock required per panel and the average
mass of coating produced per panel for a given panel size.

| | Average mass of feedstock | Average mass of |
|---|---|---|
| | required per panel (g) | coating produced (g) |
| Large | 17 | 6.0 |
| Medium | 12 | 3.4 |
| Small | 5 | 1.5 |

The coating thickness of each coated panel was measured using a MiniTest 600 gauge (Tables 9-11).

TABLE 9
Coating thickness for the small panels.

| | |
|---|---|
| Panel identifier | Estimated coating thickness (μm) |

| | | |
|---|---|---|
| Panel set | Individual | for a given measurement position |

| # | panel # | Bottom | Middle | Top |
|---|---|---|---|---|
| Blank | | 6 | 3 | 2 |
| 1 | 1 | 101 | 106 | 118 |
| | 2 | 111 | 118 | 117 |
| | 3 | 106 | 117 | 104 |
| | 4 | 98 | 116 | 104 |
| 2 | 1 | 123 | 120 | 117 |
| | 2 | 116 | 111 | 113 |
| | 3 | 121 | 117 | 114 |
| | 4 | 119 | 114 | 126 |
| 3 | 1 | 103 | 111 | 115 |
| | 2 | 104 | 119 | 102 |
| | 3 | 102 | 108 | 125 |
| | 4 | 111 | 119 | 113 |
| 4 | 1 | 107 | 112 | 113 |
| | 2 | 98 | 106 | 119 |
| | 3 | 100 | 109 | 123 |
| | 4 | 115 | 111 | 125 |
| 5 | 1 | 103 | 100 | 103 |
| | 2 | 119 | 96 | 125 |
| | 3 | 99 | 118 | 110 |
| | 4 | 117 | 124 | 108 |
| 6 | 1 | 112 | 103 | 102 |
| | 2 | 96 | 108 | 109 |
| | 3 | 99 | 113 | 109 |
| | 4 | 115 | 118 | 111 |
| 7 | 1 | 93 | 106 | 102 |
| | 2 | 103 | 105 | 121 |
| | 3 | 120 | 106 | 103 |
| | 4 | 106 | 99 | 121 |
| 8 | 1 | 111 | 113 | 122 |
| | 2 | 106 | 113 | 118 |
| | 3 | 115 | 109 | 117 |
| | 4 | 106 | 116 | 116 |

| | | | |
|---|---|---|---|
| AVERAGE | 108 | 111 | 114 |

TABLE 10
Coating thickness for the medium panels.

| | |
|---|---|
| Panel identifier | Estimated coating thickness (μm) |

| | | |
|---|---|---|
| Panel set | Individual | for a given measurement position |

| # | panel # | Bottom | Middle | Top |
|---|---|---|---|---|
| Blank | | −2 | 1 | 3 |
| 1 | 1 | 101 | 108 | 101 |
| | 2 | 116 | 94 | 95 |
| | 3 | 101 | 97 | 95 |
| | 4 | 113 | 96 | 82 |
| 2 | 1 | 110 | 101 | 98 |
| | 2 | 126 | 95 | 87 |
| | 3 | 128 | 110 | 91 |
| | 4 | 118 | 91 | 89 |
| 3 | 1 | 106 | 95 | 89 |
| | 2 | 119 | 110 | 99 |
| | 3 | — | — | — |
| | 4 | 115 | 99 | 98 |
| 4 | 1 | 113 | 92 | 90 |
| | 2 | 113 | 92 | 98 |
| | 3 | 94 | 108 | 100 |
| | 4 | 105 | 100 | 109 |
| 5 | 1 | 92 | 91 | 98 |
| | 2 | 97 | 101 | 97 |
| | 3 | 105 | 84 | 98 |
| | 4 | 106 | 87 | 100 |
| 6 | 1 | 93 | 100 | 106 |
| | 2 | 103 | 93 | 84 |
| | 3 | 94 | 97 | 95 |
| | 4 | 98 | 90 | 95 |
| 7 | 1 | 130 | 101 | 94 |
| | 2 | 113 | 96 | 95 |
| | 3 | 113 | 108 | 93 |
| | 4 | 116 | 102 | 100 |
| 8 | 1 | 111 | 98 | 97 |
| | 2 | 99 | 102 | 97 |
| | 3 | 99 | 102 | 104 |
| | 4 | 109 | 101 | 105 |

| | | | |
|---|---|---|---|
| AVERAGE | 108 | 98 | 96 |

TABLE 11
Coating thickness for the large panels.

| | |
|---|---|
| Panel identifier | Estimated coating thickness (μm) |

| | | |
|---|---|---|
| Panel set | Individual | for a given measurement position |

| # | panel # | Bottom | Middle | Top |
|---|---|---|---|---|
| Blank | | 0 | −1 | 1 |
| 1 | 1 | 94 | 64 | 68 |
| | 2 | 71 | 85 | 70 |
| | 3 | 70 | 71 | 67 |
| | 4 | 81 | 86 | 88 |
| 2 | 1 | 106 | 84 | 77 |
| | 2 | 85 | 90 | 79 |
| | 3 | 91 | 83 | 78 |
| | 4 | 93 | 85 | 76 |
| 3 | 1 | 96 | 98 | 90 |
| | 3 | 90 | 87 | 99 |
| | 4 | 92 | 99 | 87 |
| 4 | 1 | 102 | 100 | 88 |
| | 2 | 103 | 93 | 95 |
| | 3 | 95 | 98 | 88 |
| | 4 | 92 | 106 | 100 |
| 5 | 1 | 92 | 89 | 91 |
| | 2 | 93 | 92 | 90 |
| | 3 | 95 | 108 | 90 |
| | 4 | 94 | 95 | 87 |
| 6 | 1 | 94 | 99 | 97 |
| | 3 | 104 | 88 | 98 |
| | 4 | 91 | 97 | 90 |
| 7 | 1 | 99 | 95 | 87 |
| | 2 | 84 | 89 | 87 |
| | 3 | 89 | 96 | 93 |
| | 4 | 85 | 86 | 97 |
| 8 | 1 | 97 | 82 | 83 |
| | 2 | 95 | 92 | 88 |
| | 3 | 94 | 91 | 82 |
| 9 | 2 | 93 | 89 | 103 |
| | 3 | 95 | 90 | 95 |
| | 4 | 96 | 94 | 99 |

| | | | |
|---|---|---|---|
| AVERAGE | 92 | 91 | 88 |

### Example 4. Physical Properties

The properties of the coated panels prepared in Example 3 were characterised as set out below and the results for each size panel are summarised in Table 12. SS316 was used as a control surface in all experiments unless otherwise stated.

### Phase Analysis

Powder X-ray Diffraction (XRD) was used to analyse the crystalline phases present in both the precursor powders and the coatings. Spectra were collected from 5° to 80° with a step size of 0.02° and 1 second dwell time. The data presented herein is from one replicate spectrum. A Bruker® D8-Advance X-ray diffractometer with a copper X-ray source (2=1.5406 Å) was used for all diffraction measurements.

### Wettability

All contact angle analysis was performed on a First Ten Ångstroms (FTA) 1000 C Class contact angle apparatus. It is typical to define wettability by the contact angle (θ) as follows: superhydrophilic if 0°<θ<3°, hydrophilic if 3°<θ<90°, hydrophobic if 90°<θ<177°, and superhydrophobic if 177°<θ<180°. The sessile drop contact angle was measured by a contact angle goniometer using an optical subsystem to capture the profile of a water droplet on the surface of the substrate. The surface of the substrate was cleaned of debris by placing the sample in a vigorous stream of air for 30 seconds. The contact angle analysis of the samples was conducted by placing the rectangular sample on the sample platform and dropping Milli-Q water (10 μL) onto the surface with an autopipette while recording the video feed with the equipment camera. The video feed was analysed frame by frame and the contact angle between the solid-water and water-air interfaces was measured 2 frames after initial water/surface contact.

### Surface Roughness

The surface topography was analysed using an optical profilometer. The optical profiling system was operated in the green light vertical scanning interferometry (VSI). A 5× objective lens was used, combined with 1× digital multiplier which resulted in a scanning area of approximately 1.267 mm×0.95 mm. Optical profilometry was performed using the Wyko NT1100 optical profiling system using the Vision software package.

### Porosity

The porosity was analysed using RBG (red, blue, green) cross section optical microscopy. The resultant images were converted to greyscale using “XnConvert” software, then converted to black and white using “Image J” software. The pixel thresholds were adjusted in Image J to reveal the true porosity and the colours inverted such that white pixels represent porosity. The % area of white pixels was then measured in Image J.

### Photocatalysis

Methylene blue degradation was used as an indicator of likely photocatalytic activity of the samples in UV light and visible light. In the methylene blue degradation experiments, the samples were exposed to light (i.e., 366 nm) and the degradation of methylene blue was measured by spectrophotometry as the change in concentration of methylene blue measured at 665 nm.

The UV-A (366 nm) light was provided by a UV lamp (5 W at 50 Hz) in a CAMAG UV-Betrachter cabinet. The methylene blue concentration was measured using single use plastic cuvettes (1 mL) and a UV-Vis spectrometer (Thermo Fisher Genesys 30 spectrophotometer, set to λₘₐₓ=664 nm). Aliquots of 2×1 mL were removed at each time point; where 1×1 mL aliquot was used to flush the cuvette and the other 1×1 mL was analysed in the spectrophotometer.

In preparation for analysis, the samples were all cut to size (surface area approximately equals 13 cm²) and a methylene blue stock solution (618 μM) was used to make standards (1.2, 4.4, 6.9, 12.5 and 13 μM) for the calibration curve and for the methylene blue reaction media (12.5 μM). To begin the degradation experiments, the samples were loaded in the bottom of beakers (250 mL, surface coating facing up), and the samples were submerged in methylene blue reaction media (50 mL, 12.5 μM). The samples were then shielded from all light (i.e. left in the dark) for roughly 18 h to allow the absorption and desorption of methylene blue on the coating surface to stabilise. After approximately 18 h in the dark, two aliquots (2 mL each) of methylene blue solution were removed and analysed by spectrophotometry 30 minutes apart to establish a baseline for zero photocatalysis.

The experiment was continued with the UV-lamp at 366 nm. Aliquots (2 mL) were initially removed at 30 minute intervals and then removed at 60 minute intervals as the experiment progressed. The aliquots were analysed by spectrophotometry. The concentration of methylene blue was normalised such that the methylene blue concentration at the beginning of the experiment was 100%, and the reduction in methylene blue concentration (percentage fraction) was graphed as a function of time (min).

### Morphology

The surface morphology was visualised using high resolution SEM. All SEM samples were analysed without gold coating. The approximate working distance was 10 mm, and the accelerating voltage was 10 kV. All SEM images were captured using an Oxford Instruments Zeiss Supra 40VP Scanning Electron Microscope.

### Mechanical

A nanoindenter (Hysitron TI Premier, Bruker, Minneapolis, MN, USA) with a micro-indenter was used to conduct the mechanical tests, including hardness and elastic moduli. Hardness was measured using the Vickers microhardness test. In this test, a diamond indenter in the right pyramid with a square base and an angle of 136° angle between opposite faces was used to apply a load onto the coating cross-section. A force of 5000 μN was applied, with 3 μm spacing between the indents. The Vickers hardness (HV) was measured by the length of the diagonals of the indentation on the specimen.

### Ammonia Atmosphere Experiment

The ammonia atmosphere test was performed according to the ISO 6957:1988 standard. The surface area of the coating was 866 cm², the vessel volume was 4 L, the room temperature was 20° C. Ammonium chloride solution was made from 85 g of ammonium chloride salt in 900 mL, and adjusted to pH 10.59. Photos and optical microscope images were taken of the samples before and after 24 h of ammonia exposure.

### Bird Dropping Simulant

In preparation for analysis, the samples were all cut to size (area=25 cm²). The bird dropping simulant was prepared as a mix of pancreatin (1 g pancreatin: 20 g water) and uric acid (1 g uric acid: 20 g water) in distilled water. The bird dropping simulant was applied to the coatings and exposed to the coatings for 48 h. After exposure, the coupon surfaces were washed under running water to remove the bird dropping simulant. Photos and optical microscope images were collected of the coatings before and after analysis. The wettability and mass of the coupons was measured before and after analysis.

### Physical Self-Cleaning

The physical self-cleaning tests were performed by applying glitter to the surface of full-sized LPI panels and squirting water from a laboratory wash bottle onto the surface of the panel. The wetting procedure was video recorded and analysed to determine the self-cleaning mechanism. Fine glitter was compared to needle shaped glitter and large (5 mm) glitter.

### Environment Test

Full-sized panels were placed on the roof of a building at approximately 3 m elevation. The panels were photographed once a month for 6 months. The wettability of the coating was measured by squirting water from a laboratory wash bottle onto the surface of the panel and recording the interaction between the water and the panel.

### Salt Spray

The corrosion resistance of the coatings was examined using a Testex TU389 salt spray tester in accordance with the ISO9227 2017 standard. The panels were placed in the salt spray apparatus without any further preparation. The samples were orientated at an angle of 20° from vertical. Tap water was used to fill the chamber vessel to the overflow, a saltwater solution (5%, pH 6.5) was added to the salt spray tester, and the chamber temperature was set at 35° C. The spray pressure was set at 1 bar and the pressure temperature at 47° C. The experiment was conducted for 10 days. The samples were photographed at 24 hour intervals.

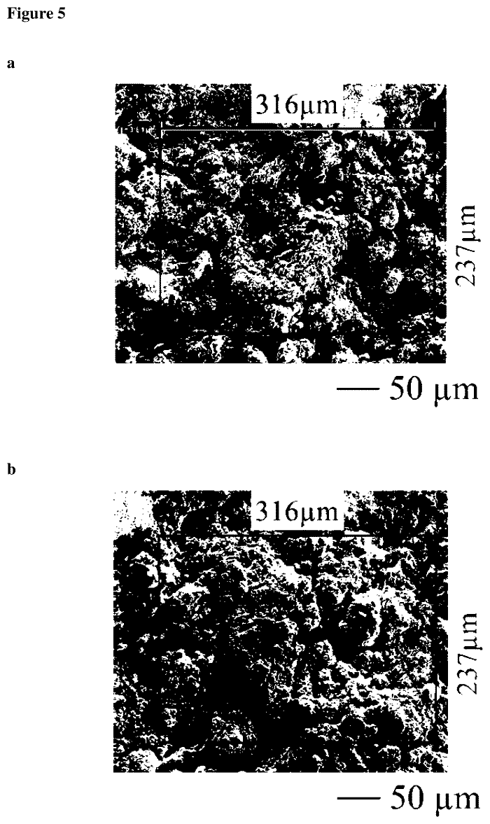

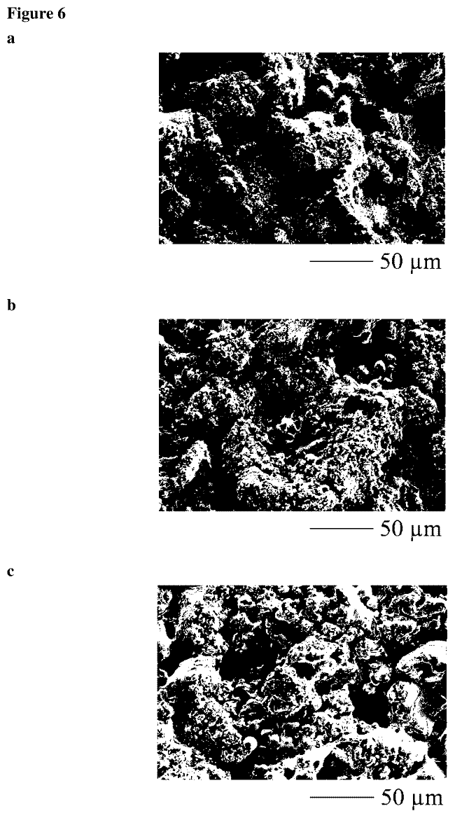

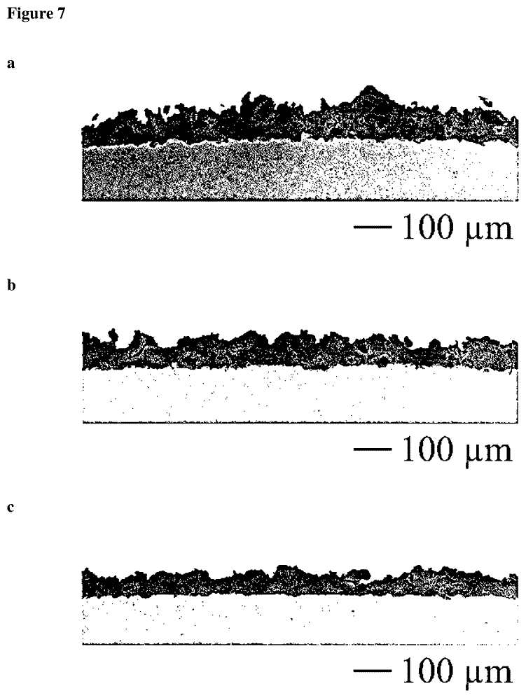

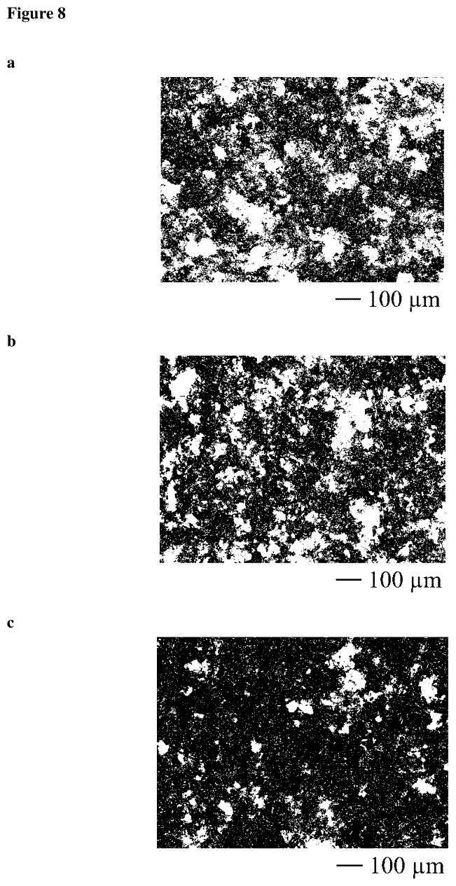

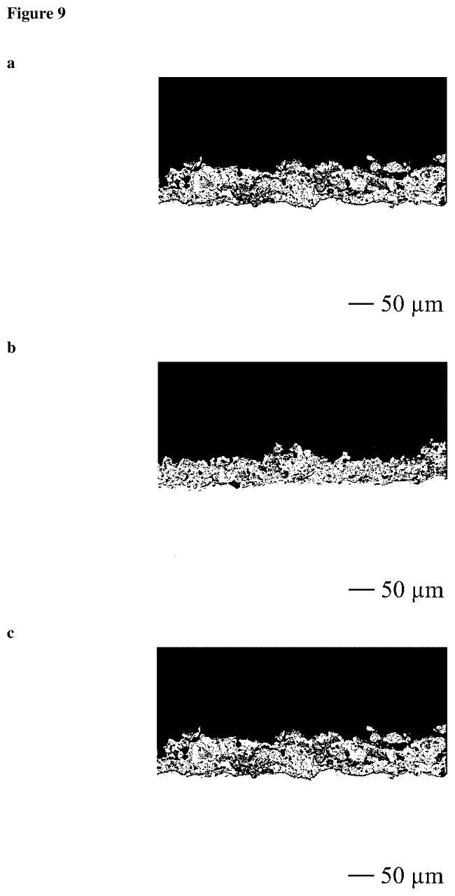

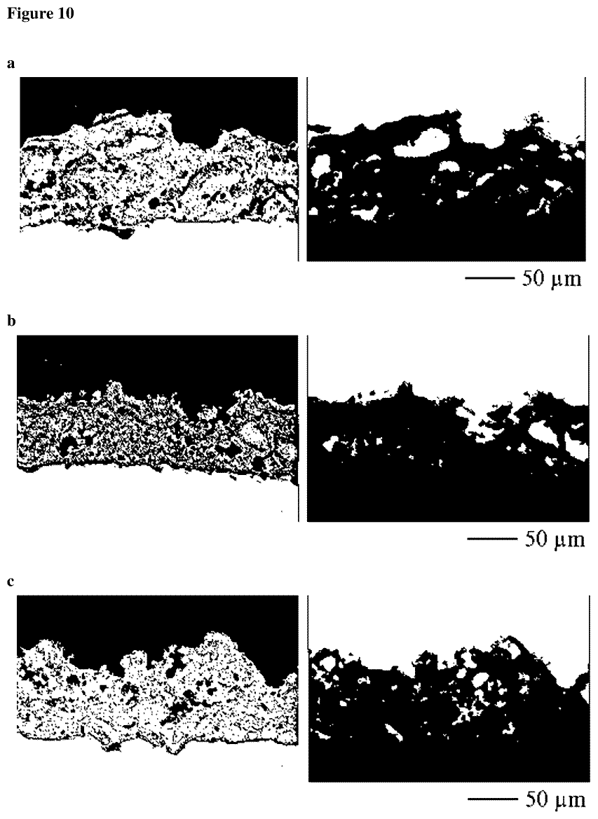

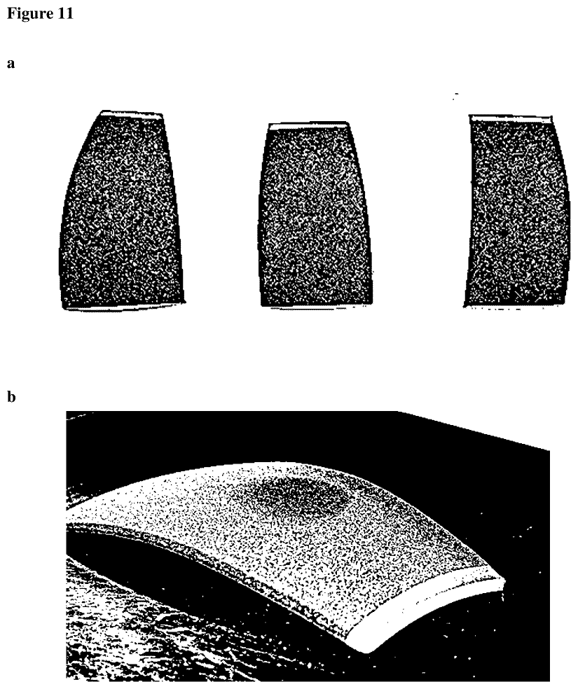

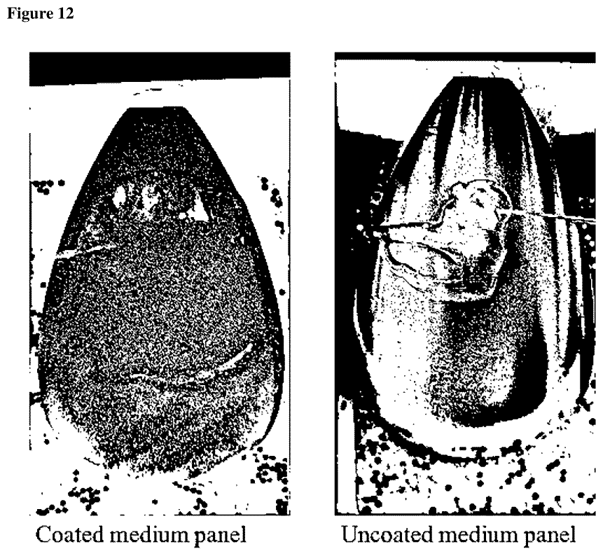

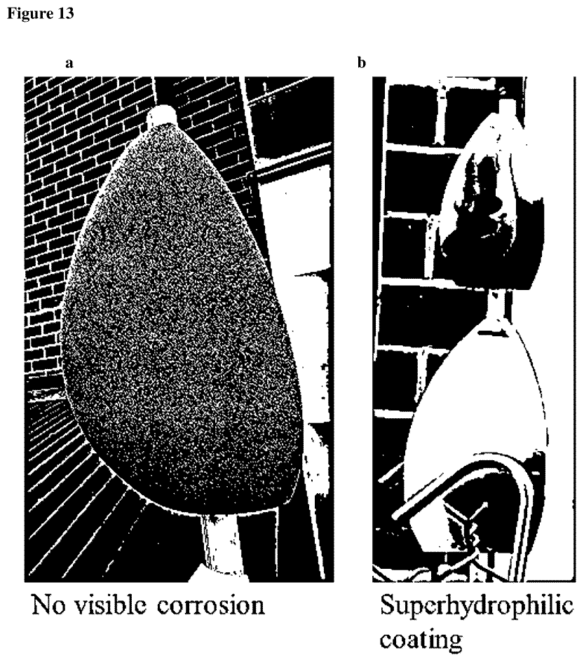

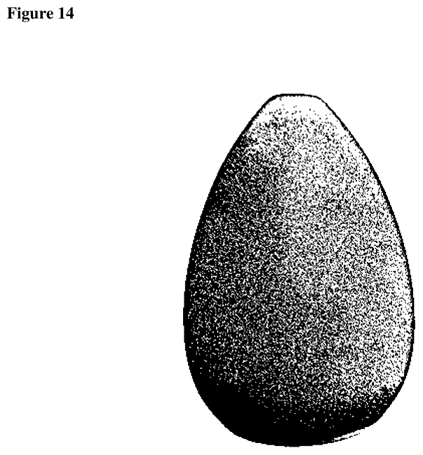

TABLE 12
Summary of the characterisation results from each size prototype panel of Example 3.

| Characterisation | Technique | Small | Medium | Large |
|---|---|---|---|---|
| Phase analysis | XRD | 24% anatase + | 28% anatase + | 29% anatase + 71% |
| | | 76% rutile ± | 72% rutile ± | rutile ± |
| | | 0.08% (1 st. | 1.8% (1 st. dev.) | 0.5% (1 st. dev.) |
| | | dev.) | | |
| Wettability | Water contact | Superhydrophilic^{#} | Superhydrophilic^{#} | Superhydrophilic^{#} |
| | angle (WCA) - | | | |
| | after | | | |
| | preparation | | | |
| | Water contact | Not measured | Superhydrophilic | Not measured |
| | angle - | | | |
| | after 6 months | | | |
| | in the dark | | | |
| Surface | Optical profile | 12.25 ± 1.7 μm | 11.97 ± 1.5 μm | 10.48 ± 1.0 μm |
| roughness | (Sa) | | | |
| | SEM image of | Not measured | See FIG. 5a | See FIG. 5b |
| | profiled region | | | |
| Porosity | RBG cross | 12.8% | 6.5% | 9.5% |
| | section optical | | | |
| | microscopy | | | |
| Photocatalysis | Methylene blue | 54 ± 4% | 70 ± 2% | 62 ± 2% |
| | degradation | | | |
| | under UVA * | | | |
| | Daylight under | Not active ^{‡} | Not active ^{‡} | Not active ^{‡} |
| | solar simulator ^{†} | | | |
| Morphology | SEM - top | See FIG. 6a | See FIG. 6b | See FIG. 6c |
| | surface | | | |
| | SEM - cross | See FIG. 7a | See FIG. 7b | See FIG. 7c |
| | section | | | |
| | Optical | See FIG. 8a | See FIG. 8b | See FIG. 8c |
| | microscope - top | | | |
| | surface | | | |
| | Optical | See FIG. 9a | See FIG. 9b | See FIG. 9c |
| | microscope - | | | |
| | cross section | | | |
| | Optical | See FIG. 10a | See FIG. 10b | See FIG. 10c |
| | microscope - UV - | | | |
| | cross section | | | |
| Mechanical | Adhesion test - | Not measured | Not measured | 2.09 ± 0.0.1 MPa |
| | after | | | (glue fail) |
| | preparation | | | |
| | Adhesion test - | Not measured | 2.9 ± 0.8 MPa | Not measured |
| | after salt spray | | (glue fail) | |
| | Adhesion test - | 4.0 ± 0.6 MPa | | |
| | flat coupon | (Glue and coating fail) | | |
| | Hardness | 13 GPa | 11 GPa | 12 GPa |
| | (nanoindents) ^{§} | | | |
| | Modulus | 157 GPa | 137 GPa | 146 GPa |
| | (nanoindents) ^{§} | | | |

| Ammonia atmosphere experiment \hat{ }¶ | No cracking | No cracking | Not measured |
|---|---|---|---|
| Bird dropping simulant (Simulant | Not measured | No visible damage | Not measured |
| was 1 g uric acid + 1 g pancreatin in | | or corrosion after 4 | |
| 10 g water water) | | days exposed to | |
| | | bird dropping | |
| | | simulant. A photo | |
| | | of the three coupons | |
| | | after 4 days of bird | |
| | | dropping simulant | |
| | | (and washing the | |
| | | coating) is shown in | |
| | | FIG. 11a. | |
| | | Sample remained | |
| | | superhydrophilic | |
| | | after bird droppings | |
| | | were washed away. | |
| | | A photo of the | |
| | | WCA test after 4 | |
| | | days of bird | |
| | | dropping simulant | |
| | | (and washing the | |
| | | coating) is shown in | |
| | | FIG. 11b. | |
| Physical self-cleaning | Not measured | Superhydrophilic | Not measured |
| | | coating has | |
| | | excellent physical | |
| | | self-cleaning | |
| | | properties. Photos | |
| | | of the self-cleaning | |
| | | process is shown in | |
| | | FIG. 12. | |
| Environment test | Not measured | Superhydrophilic | Not measured |
| | | after 3 months. No | |
| | | signs of corrosion. | |
| | | Photos of | |
| | | environment sample | |
| | | after 2 months are | |
| | | shown in FIG. | |
| | | 13. | |
| Salt spray | Not measured | No corrosion after | Not measured |

10 days (see FIG.
14).

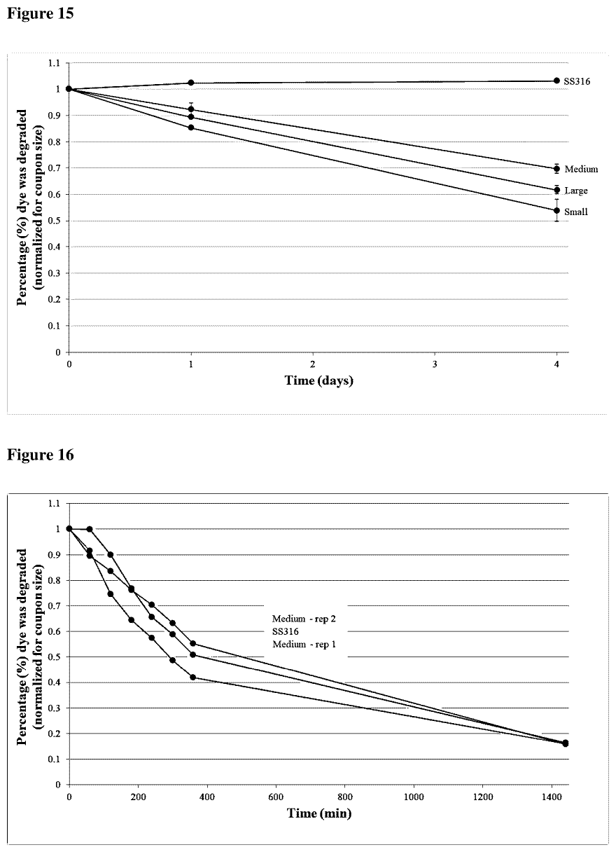

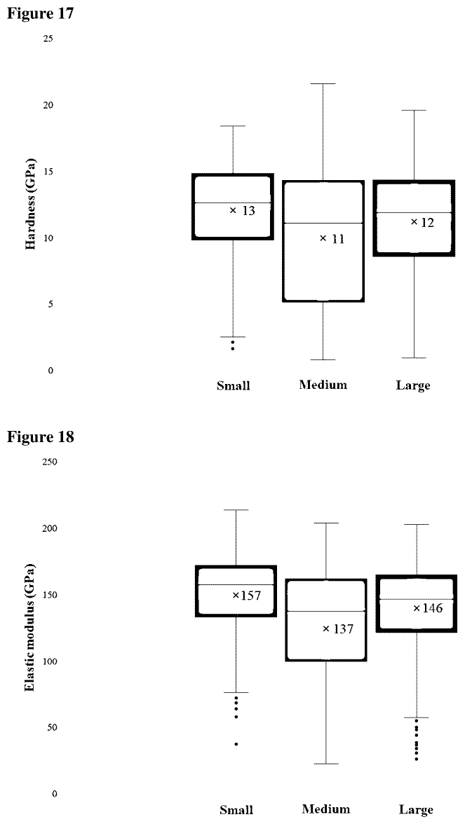

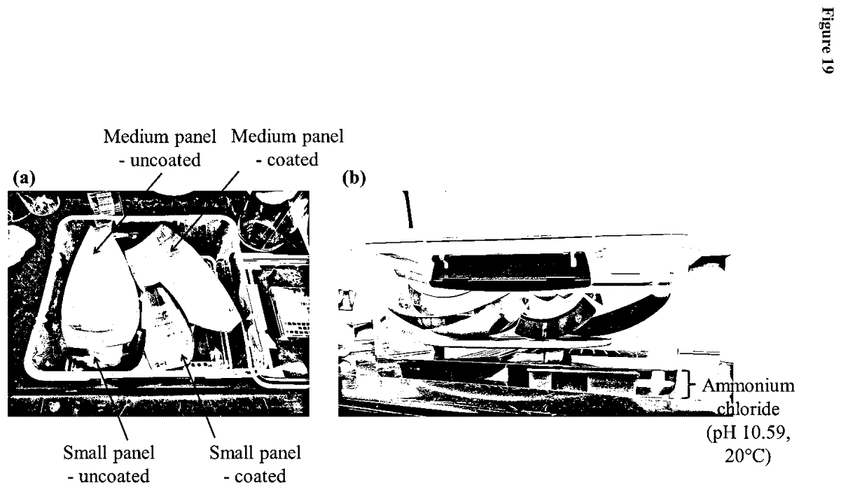

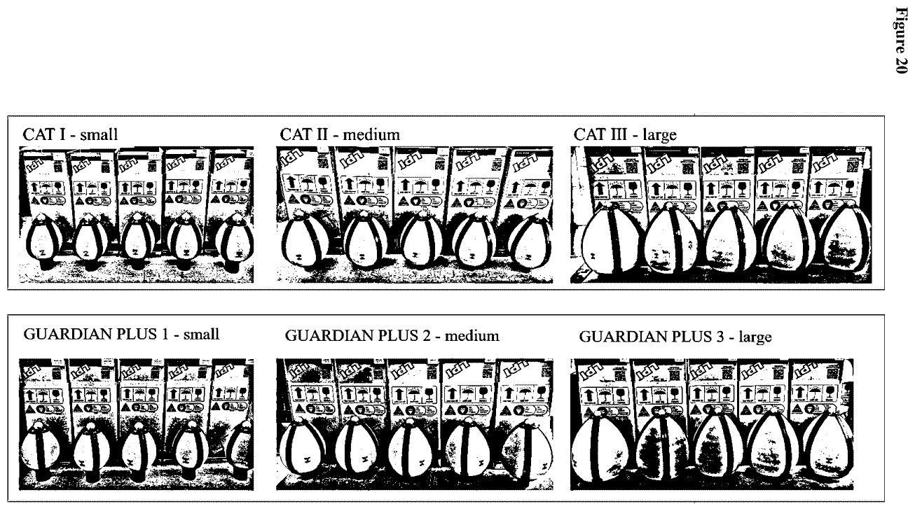

^{#}Superhydrophilic: <10 degrees
* Percentage of dye degraded after 4 days under UVA light (366 nm). Refer to FIG. 15 for graphical plot.
^{†} Percentage of dye degraded after 1 day under a daylight solar simulator. Refer to FIG. 16 for graphical plot.
^{‡} Methylene blue degrades under daylight. The coating may be active, but the rate of methylene blue degradation was too quick to allow the photocatalysis to be measured.
^{§} Refer to FIG. 17 for graphical plot of nanoindentation hardness and FIG. 18 for graphical plot of nanoindentation elastic modulus.
\hat{ } Refer to FIG. 19 for photos of the ammonia atmosphere experiment.

The selected APS parameters produced a coating with chemical and physical properties including good anatase retention, photocatalytic chemistry, and porosity, as well as low surface roughness, high adhesion strength and acceptable mechanical properties. The additives did not have a significant effect on the photochemical activity of the TiO₂ coating or preservation of the anatase phase through the APS process.

### Example 5. Corona Testing

Coated panels prepared in accordance with Example 3 were assembled into the final prototype air terminals, each comprising four panels, as shown in.

The corona characteristics of six prototype air terminals (three coated; three uncoated) and a Franklin rod were measured under negative and positive high voltage electric fields in L.C.O.E. High Voltage laboratory in Tecnogetafe, Madrid according to UNE-EN 60060-1:2012, “Técnicas de ensayo de alta tension. Parte 1: Definiciones generales y requisitos de ensayo” Spanish official version of the European Standard EN 60060-1:2010, which adopts the modified International Standard IEC 60060-1:2010.

The dimensions of the test assembly were as follows:
Distance between overhead electrode (OE) and ground (H): 4.00 m
Height of the air terminals (h): 2.00 m
Distance between OE and air terminal (d): 2.00 m
Diameter of overhead electrode (OE): 4.00 m

High voltage DC was applied slowly on the overhead electrode from 25 kV up to 400 kV in steps of 20 kV with the air terminal connected to ground. Test voltage polarity was both negative and positive. A DC current meter was used to measure the current to ground of the tested air terminal for each voltage level applied to the overhead electrode. The main electrical parameters during the tests were as follows:
Test voltage, HVDC: up to ±400 kV (100 kV/m±3%)
Test voltage steps: 20 kV
Voltage polarity: Negative and Positive

The climatic conditions inside the testing room, pressure, temperature and relative humidity were recorded during the test for each air terminal. Corona current test was performed first in dry condition and then was repeated in wet condition according to IEC 60060-1 Standard applying standardized rain directly on the test object for 15 minutes before the test and during the current measurement.

Characteristics of wet condition:
Water Conductivity: 100 μS/cm (±15 μS/cm)
Water temperature: 15° C. (±5° C.)
Horizontal flow rate: 1.5 mm/min (±0.5 mm/min)
Vertical flow rate: 1.5 mm/min (±0.5 mm/min)

The corona current was measured first in the Franklin rod for reference in dry and wet condition and the test was repeated on six air terminals with HV DC generator for negative and positive polarity output. Test voltage applied to overhead electrode (OE) was increased in steps of 20 kVDC up to maximum test voltage of 400 kVDC and the DC current to ground was measured for each voltage level.

Preliminary data indicate a significant reduction in corona discharge from the prototype air terminals relative to Franklin rods in both wet and dry conditions.

1. An air terminal or a component thereof comprising an outer surface that is at least partially coated with a superhydrophilic coating, wherein the coating comprises an N-doped titanium dioxide (TiO₂) in an amount of at least about 70 wt %, wherein at least about 15 wt % of the TiO₂ is in the form of anatase, and wherein the coating has an average thickness of between about 20 μm and about 300 μm.

2. The air terminal or a component thereof of claim 1, wherein the coating comprises N-doped TiO₂ in an amount of at least about 90 wt %.

3. The air terminal or a component thereof of claim 1, wherein the coating comprises N-doped TiO₂ in an amount of at least about 99 wt %.

4. The air terminal or a component thereof of claim 1, wherein at least about 20 wt % of the TiO₂ is in the form of anatase.

5. The air terminal or a component thereof of claim 1, wherein at least about 25 wt % of the TiO₂ is in the form of anatase.

6. The air terminal or a component thereof of claim 1, wherein the coating has an average thickness of between about 60 μm and about 130 μm.

7. The air terminal or a component thereof of claim 1, wherein the coating has an average thickness of about 100 μm.

8. The air terminal or a component thereof of claim 1, wherein the contact angle of water with the coated outer surface is less than about 10 degrees.

9. The air terminal or a component thereof of claim 1, wherein the contact angle of water with the coated outer surface is about 5 degrees or less.

10. The air terminal or a component thereof of claim 1, wherein the contact angle of water with the coated outer surface is about 2 degrees or less.

11. The air terminal or a component thereof of claim 1, wherein the arithmetic mean height (Sa) of the coated surface is about 20 μm or less.

12. The air terminal or a component thereof of claim 1, wherein the arithmetic mean height (Sa) of the coated surface is about 15 μm or less.

13. The air terminal or a component thereof of claim 1, wherein the coating further comprises one or more additives in an amount up to about 30 wt %.

14. The air terminal or a component thereof of claim 13, wherein the additive is selected from a cobalt oxide (CoOₓ), cobalt titanate (Co₂TiO₄), iron (Fe), an iron oxide (FeOₓ), Al₂O₃, and silica (SiO₂).

15. The air terminal or a component thereof of claim 1, wherein substantially the entire outer surface is coated with the superhydrophilic coating.

16. The air terminal or a component thereof of claim 1, wherein the outer surface is a stainless steel surface.

17. The air terminal or a component thereof of claim 1, wherein the air terminal is an active response air terminal.

18. An air terminal comprising an outer surface that is at least partially coated with a superhydrophilic coating as defined in claim 1.

19. (canceled)

20. A method for at least partially coating an air terminal or a component thereof with a superhydrophilic coating, the method comprising:
(i) providing a powder feedstock comprising at least about 70 wt % TiO₂, wherein at least about 50 wt % of the TiO₂ is in the form of anatase; and
(ii) at least partially coating an outer surface of an air terminal or a component thereof with the powder feedstock using atmospheric plasma spray (APS) with N₂ as a powder feedstock carrier gas to a thickness of between about 20 μm and about 300 μm.

21. The method of claim 20, wherein at least about 55 wt % of the TiO₂ present in the powder feedstock is in the form of anatase, preferably wherein the powder feedstock has an average particle size between about 25 μm and 125 μm.

22. (canceled)
